(19) United States
(12) Patent Application Publication
(10) Pub. No.: US 2026/0321145 A1
(43) Pub. Date: Oct. 15, 2026

(54) FLIGHT SYSTEM WITH DYNAMIC FAILURE GUIDANCE

(71) Applicant: Garmin International, Inc., Olathe, KS (US)

(72) Inventors: Philip I. Straub, Olathe, KS (US); Terry L. McDonough, Scottsdale, AZ (US); Garrett W. van Ark, Scottsdale, AZ (US); Kavik Bachani, Olathe, KS (US)

(21) Appl. No.: 19/647,328

(22) Filed: Apr. 14, 2026

Related U.S. Application Data
(60) Provisional application No. 63/788,567, filed on Apr. 14, 2025.

(51) Int. Cl. G08G 5/50; B64C 13/18; B64D 43/00; B64D 45/04; G08G 5/23; G08G 5/80

(52) U.S. Cl. CPC G08G 5/50; B64C 13/18; B64D 43/00; B64D 45/04; G08G 5/23; G08G 5/80

(57) ABSTRACT

A system for dynamic guidance for aircraft can include a processor configured to obtain one-engine-inoperative (OEI) data to generate an OEI path based on the OEI data. The OEI data can include projected OEI climb performance of the aircraft, locations of ground-based obstacles in proximity to the aircraft, obstacle clearance requirements, and a location and altitude of the aircraft. The system can include a user interface configured to display the OEI path with a unique line style. The OEI path can visually represent a flight path that meets the obstacle clearance requirements given the projected OEI climb performance, the locations of ground-based obstacles, and the location and altitude of the aircraft.

### RELATED APPLICATIONS

This application claims priority to U.S. provisional application 63/788,567 filed Apr. 14, 2025, the contents of which are hereby incorporated by reference herein.

### TECHNICAL FIELD

The present disclosure relates generally to systems, methods, and executable instructions for dynamic guidance for one-engine-inoperative aircraft.

### BACKGROUND

In typical aircraft takeoff and landing procedures, the height above ground of obstacles surrounding an airport may be known. A pilot of an aircraft may be in communication with airport personnel such as air traffic controllers. In the event of a malfunctioning engine during takeoff the pilot may abort the takeoff and stop on the runway. However, if the aircraft has reached a takeoff decision speed or if the aircraft is in the air, the pilot may have no other option than to fly the aircraft with the malfunctioning engine or with the engine out.

### BRIEF DESCRIPTION OF THE DRAWINGS

The detailed description references the accompanying figures. The use of the same reference numbers in different instances in the description and the figures may indicate similar or identical items. In addition, the proportion and the relative scale of the elements provided in the figures are intended to illustrate various embodiments and are not to be used in a limiting sense.

FIG. 1 illustrates an example of an integrated avionics system.

FIG. 2 is a block diagram illustrating an example of a control system for the integrated avionics system of FIG. 1.

FIG. 3 is a block diagram illustrating an example of a computing system.

FIG. 4 illustrates an example of a user interface displaying a one-engine-inoperative pane.

FIG. 5 illustrates an example of a user interface displaying a one-engine-inoperative path in a preflight environment.

FIG. 6 illustrates an example of a user interface displaying a one-engine-inoperative path in a flight environment.

### DETAILED DESCRIPTION

The present disclosure describes systems, methods, and executable instructions for dynamic guidance for one-engine-inoperative (OEI) aircraft. The dynamic guidance can include an OEI path, an all-engines-operative (AEO) path, or both, which can be generated and displayed to the flight crew prior to takeoff. Such dynamic guidance can provide improved situational awareness to pilots of aircraft, particularly multiengine aircraft, who may experience an engine malfunction or failure during or after takeoff. The dynamic guidance may be presented via a user interface, which can include a moving map display or a static graphical depiction. By way of example, the user interface (e.g., graphical user interface (GUI)) can be presented on a primary flight display (PFD), multifunction display (MFD), electronic flight bag (EFB), or tablet-based flight planning tool.

The system can utilize pre-defined OEI paths stored in the aircraft’s flight management database to perform takeoff and landing data (TOLD) calculations, including maximum rated takeoff weight (MRTW) determinations, based on projected aircraft performance, environmental conditions, and airport layout. These OEI paths may be developed in accordance with obstacle departure procedures and integrated into the preflight charting logic to visually represent safe departure corridors under degraded power conditions.

In some embodiments, both an intended AEO path and a fallback OEI path can be displayed simultaneously for comparison and decision support. The system can obtain AEO data to generate the AEO path based on the AEO data. The AEO data can include a flight plan, which may include a standard instrument departure (SID), obstacle departure procedure (ODP), or another departure procedure (DP). The OEI path can be displayed with a unique line style. The AEO path and OEI path can be displayed with different line styles. For example, the AEO path can be displayed as a solid line, while the OEI path can be overlaid on the same user interface as a dashed line. Such a dual-path display enables flight crews to visually assess the divergence between the two trajectories and identify key points where the OEI path may deviate from the AEO path. Such deviations may be due to regulatory, weather, or terrain-driven obstacle clearance requirements. This visualization enhances situational awareness, especially in complex airspace or high-terrain environments, by clearly distinguishing between the AEO path (nominal path) and the OEI path (degraded performance path).

Further, the system may identify and render “No-Go Zones” on the user interface, defined as geographic areas that should not be entered in the event of an OEI condition. These No-Go Zones can be derived from predicted aircraft altitude at the anticipated diversion point (which may also be referred to as an AEO-to-OEI diversion point), factoring in aircraft performance data, environmental conditions, and obstacle databases such as those used for the terrain awareness and warning system (TAWS). The No-Go Zones can be displayed on the user interface and remain static until a triggering event occurs, such as the aircraft reaching a pre-calculated minimum diversion altitude, which is typically no less than 400 feet above ground level (AGL). Once this altitude is reached, the No-Go Zones may begin to update dynamically to reflect actual aircraft position, climb rate, and configuration, enabling real-time terrain and obstacle clearance guidance in the early departure phase.

In operational use, such dynamic guidance is especially valuable in scenarios where deviations from the planned departure are introduced late in the takeoff sequence. For example, if the aircraft may be issued a modified departure clearance such as “Cleared for takeoff, fly heading 350.” The flight crew may consult the user interface to determine whether this heading intersects with any displayed No-Go Zones. The presence of such zones immediately informs the crew whether accepting the heading vector is advisable under OEI conditions. In some embodiments, the system may also provide a visual or auditory advisory if the given vector would conflict with OEI terrain clearance requirements, thereby supporting compliance with obstacle accountability standards and enhancing safety during dynamic air traffic control (ATC) interactions. The dynamic guidance for aircraft described herein may be provided in the context of the following example environment.

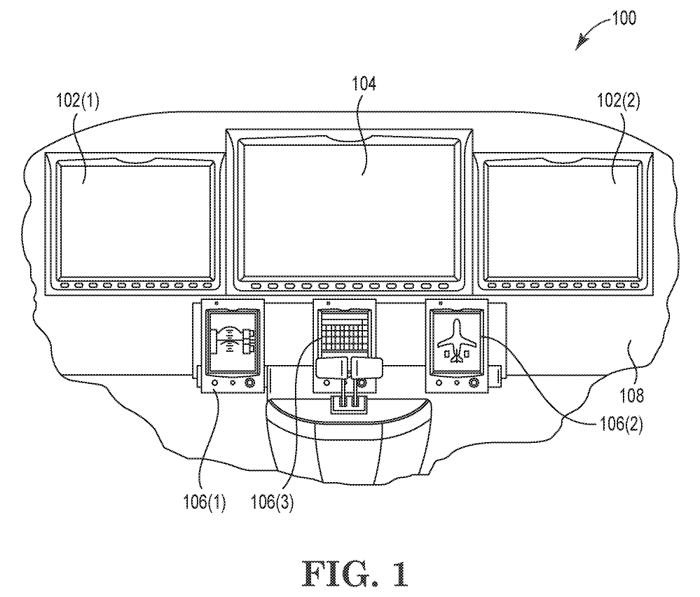

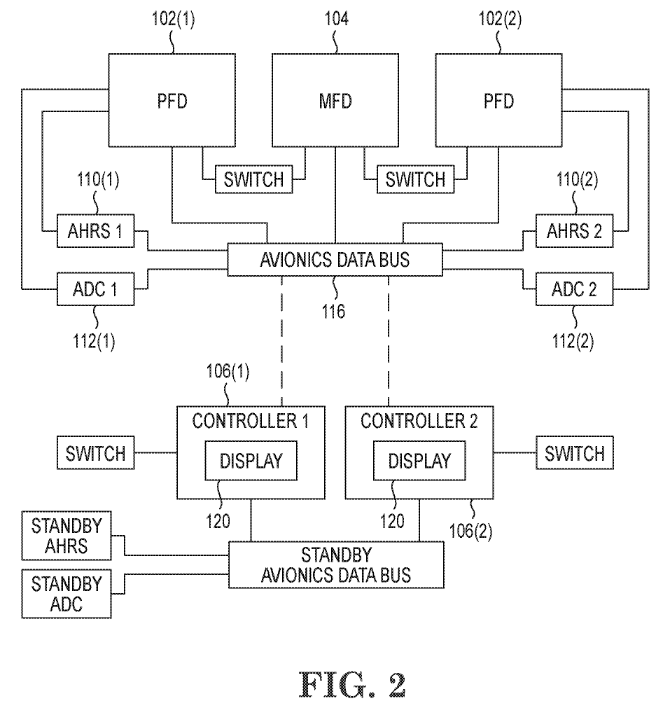

FIG. 1 illustrates an example of an integrated avionics system 100 that can be configured to provide a user interface. FIG. 2 is a block diagram illustrating an example of a control system for the integrated avionics system of FIG. 1. However, in other embodiments, the user interface is provided by a tablet or an electronic flight bag. In some embodiments, the integrated avionics system 100 can include one or more PFDs 102, one or more MFDs 104, and one or more multi-product avionics control and display units (CDU 106). For instance, in the implementation illustrated in FIG. 1, the integrated avionics system 100 can be configured for use in an aircraft that is flown by one or two pilots (e.g., a pilot and a copilot). In this implementation, the integrated avionics system 100 can include a first PFD 102(1), a second PFD 102(2), an MFD 104, a first CDU 106(1), and a second CDU 106(2), and a third CDU 106(3) that are mounted in the aircraft’s instrument panel 108. As shown, the MFD 104 is mounted generally in the center of the instrument panel 108 so that it can be accessed by either pilot (e.g., by either the pilot or the copilot). The first PFD 102(1) and the first CDU 106(1) are mounted in the instrument panel 108 generally to the left of the MFD 104 for viewing and access by the pilot. Similarly, the second PFD 102(2) and the second CDU 106(2) are mounted in the instrument panel 108 generally to the right of the MFD 104 for viewing and access by the aircraft’s copilot or other crew member or passenger. The third CDU 106(3) can be mounted between the first and second CDUs 106(1), 106(2). In implementations, the CDUs 106 can be positioned within the instrument panel 108 so that they may be readily viewed and/or accessed by the pilot flying the aircraft (which could be either the pilot or copilot).

The PFDs 102 can be configured to display primary flight information, such as aircraft attitude, altitude, heading, vertical speed, and so forth. In implementations, the PFDs 102 can display primary flight information via a graphical representation of basic flight instruments such as an attitude indicator, an airspeed indicator, an altimeter, a heading indicator, a course deviation indicator, and so forth. The PFDs 102 can also display other information providing situational awareness to the pilot such as terrain information, ground proximity warning information, and so forth.

The primary flight information can be generated by one or more flight sensor data sources including, for example, one or more attitude, heading, angular rate, and/or acceleration information sources such as attitude and heading reference systems (AHRS) 110 such as 110(1) and 110(2), one or more air data information sources such as air data computers (ADCs) 112 such as 112(1) and 112(2), and/or one or more angle of attack information sources. For instance, the AHRSs 110 can be configured to provide information such as attitude, rate of turn, slip and skid. The ADCs 112 can be configured to provide information including airspeed, altitude, vertical speed, and outside air temperature. Other configurations are possible.

Integrated avionics units (IAUs) can aggregate the primary flight information from the AHRS 110 and ADC 112 and, in one example configuration, provide the information to the PFDs 102 via an avionics data bus 116. In other examples, the various IAUs can directly communicate with each other and other system components. The IAUs can also function as a combined communications and navigation radio. For example, the IAUs can include a two-way very high frequency (VHF) communications transceiver, a VHF navigation receiver with glide slope, a global navigation satellite system (GNSS) receiver, such as a global positioning system (GPS) receiver, and so forth. As shown, each integrated avionics unit can be paired with a primary flight display, which can function as a controlling unit for the integrated avionic unit. In implementations, the avionics data bus 116 can comprise a high speed data bus (HSDB), such as data bus complying with ARINC 429 data bus standard promulgated by the Airlines Electronic Engineering Committee (AEEC), a MIL-STD-1553 compliant data bus, and so forth. A radar altimeter can be associated with one or more of the IAUs, such as via data bus 116 or a direct connection, to provide precise elevation information (e.g., height above ground) for autoland functionality. For example, in some configurations, the integrated avionics system 100 includes a radar altimeter to assist an autoland module in various functions of the landing sequence, such as timing and maintaining the level-off and/or flare.

The MFD 104 displays information describing operation of the aircraft such as navigation routes, moving maps, engine gauges, weather radar, ground proximity warning system (GPWS) warnings, traffic collision avoidance system (TCAS) warnings, airport information, and so forth, that are received from a variety of aircraft systems via the avionics data bus 116.

The CDUs 106 can furnish a general purpose pilot interface to control the aircraft’s avionics. For example, the CDUs 106 allow the pilots to control various systems of the aircraft such as the aircraft’s autopilot system, flight director (FD), electronic stability and protection (ESP) system, autothrottle, navigation systems, communication systems, engines, and so on, via the avionics data bus 116. In implementations, the CDUs 106 can also be used for control of the integrated avionics system 100 including operation of the PFD 102 and MFD 104. In some embodiments, the PFD 102 can be a separate wired or wireless computer or mobile device such as a tablet.

The physical display 120 displays information to the pilot of the aircraft. In implementations, the physical display 120 can comprise an LCD (Liquid Crystal Diode) display, a TFT (Thin Film Transistor) LCD display, an LEP (Light Emitting Polymer or PLED (Polymer Light Emitting Diode)) display, a cathode ray tube (CRT), and so forth, capable of displaying text and/or graphical information, such as a graphical user interface. The physical display 120 can be backlit via a backlight such that it can be viewed in the dark or other low-light environments.

The physical display 120 can include a touch interface, which can detect a touch input within a specified area of the physical display 120 for entry of information and commands. In implementations, a touch screen can employ a variety of technologies for detecting touch inputs. For example, the touch screen can employ infrared optical imaging technologies, resistive technologies, capacitive technologies, surface acoustic wave technologies, and so forth. In implementations, buttons, softkeys, keypads, knobs and so forth, can be used for entry of data and commands instead of or in addition to the touch screen.

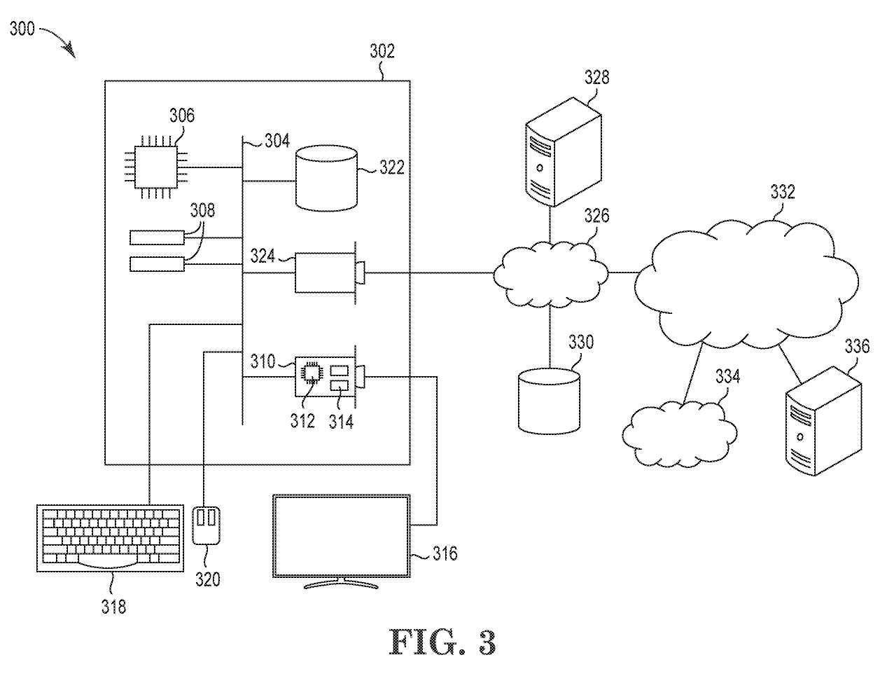

FIG. 3 is a block diagram illustrating an example of a computing system 300. The computing system 300 can include a computer 302, which can be a desktop computer, a laptop computer, a server computer, a mobile device such as a smartphone or tablet, or any other form factor of general- or special-purpose computing device. Depicted with the computer 302 are several components, for illustrative purposes. In some embodiments, certain components may be arranged differently or may be absent. Additional components may also be present. In some embodiments, the computer 302 and/or the computing system 300 can be wired or wirelessly coupled to the integrated avionics system 100. Included in the computer 302 is a system bus 304, whereby other components of the computer 302 can communicate with each other. In certain embodiments, there can be multiple busses or components that can communicate with each other directly (e.g., without the system bus 304). Such components can include a central processing unit (CPU) 306, one or more random-access memory (RAM) modules 308, and/or a graphics card 310. In some embodiments, the graphics card 310 may not be a physically separate card, but rather can be integrated into the motherboard or the CPU 306. In some embodiments, the graphics card 310 has a separate graphics-processing unit (GPU) 312, which can be used for graphics processing or for general purpose computing. The graphics card 310 can include or be coupled to GPU memory 314. The graphics card 310 can be coupled to a physical display 316 for user interaction. In some embodiments no physical display is present, while in others it is integrated into the computer 302. Similarly, peripherals such as keyboard 318 and mouse 320 can be coupled to the system bus 304. Like physical display 316, these peripherals can be integrated into the computer 302 or absent. Also coupled to the system bus 304 is local storage 322, which can be any form of computer-readable media, and can be internally installed in the computer 302 or externally and removably attached.

Computer-readable media include both volatile and nonvolatile media, removable and nonremovable media, and media readable by a database. For example, computer-readable media include (but are not limited to) RAM, read-only memory (ROM), electrically erasable programmable ROM (EEPROM), flash memory (e.g., a secure digital (SD) memory card, a mini-SD memory card, and/or a micro-SD memory card), magnetic memory, optical memory (e.g., compact discs (CDs), digital versatile discs (DVDs)), universal serial bus (USB) memory devices, hard disk memory, external memory, holographic media, and so forth. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

A network interface card (NIC) 324 can be coupled to the system bus 304 and allow the computer 302 to communicate over a network 326. The NIC 324 can be any form of network interface known in the art, such as Ethernet, asynchronous transfer mode (ATM), fiber, Bluetooth, or Wi-Fi (e.g., the IEEE 802.11 family of standards). The network 326 can include one or more other computers, such as the computer 328, and network storage, such as the data store 330. Generally, the data store 330 can be any repository from which information can be stored and retrieved as needed. Examples of data stores include relational or object-oriented databases, spreadsheets, file systems, flat files, directory services such as lightweight directory access protocol (LDAP) and Active Directory, or email storage systems. A data store can be accessible via an application program interface (API), such as complex APIs (e.g., Structured Query Language (SQL)), simple APIs providing read, write, and seek operations, or any level of complexity in between. Some data stores can additionally provide management functions for data sets stored therein such as backup or versioning. Data stores can be local to a single computer 328, accessible on a local network 326, or remotely accessible over the Internet 332. The local network 326 can be coupled to the Internet 332, which couples many networks such as the local network 326, the remote network 334, or directly attached computers such as the computer 336. In some embodiments, the computer 302 can itself be directly coupled to the Internet 332.

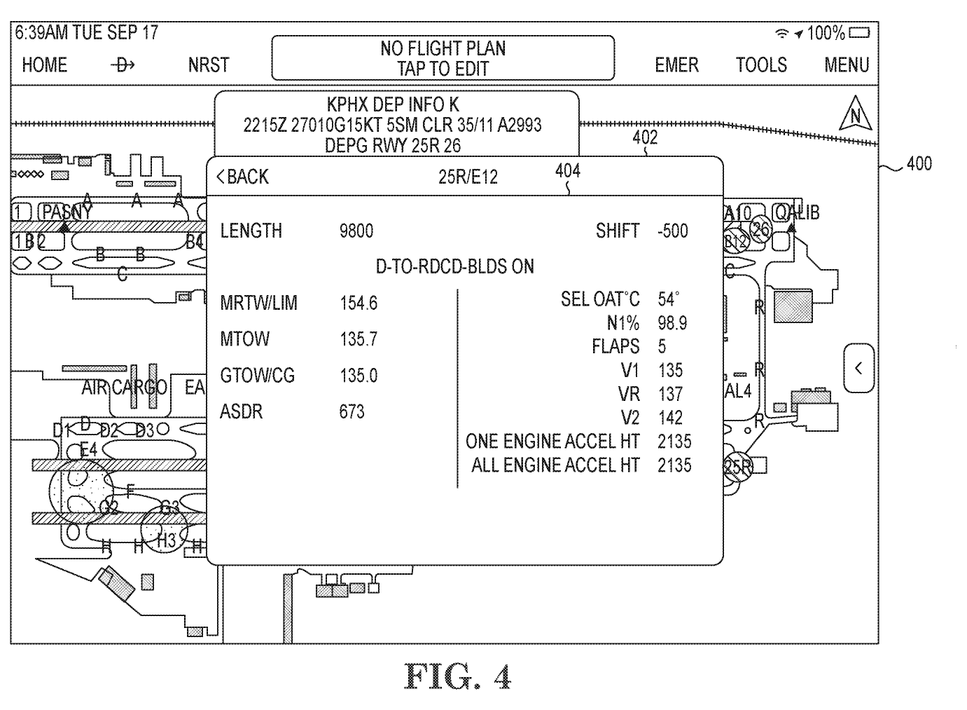

FIG. 4 illustrates an example of a user interface 400 displaying an OEI pane 402. The OEI pane 402 may also be referred to as a screen, a splash screen, a window, or a pop-up. The user (e.g., pilot or co-pilot), can access the OEI pane 402 by interacting with the user interface 400 by clicking or hovering a curser over an icon, clicking, or simply touching a touchscreen. In some embodiments, the OEI pane 402 is automatically displayed when a triggering event (e.g., engine out, takeoff, etc.) occurs. The OEI pane 402 can be displayed in any region of the display as shown in FIG. 4.

The OEI pane 402 can list OEI data 404, such as airport characteristics and aircraft characteristics. For example, the OEI data 404 can include runway lengths, aircraft takeoff weights, aircraft stop distances, runway conditions, aircraft configuration, atmospheric conditions, aircraft speed requirements, and acceleration heights for all engines and one-engine-out conditions as illustrated in FIG. 4. In some embodiments, the OEI data 404 can include projected OEI climb performance of the aircraft, locations of ground-based obstacles in proximity to the aircraft, obstacle clearance requirements, and a location and altitude of the aircraft. The location of the aircraft can be based on input from a GNSS receiver. The altitude can be based on input from the GNSS receiver and/or an altimeter. The OEI data 404 can include an engine failure notification from an engine management system of the aircraft. The OEI data 404 can include location-referenced population data and avoidance criteria for locations based on population density. Such avoidance criteria can include minimum safe altitudes (e.g., as published by the Federal Aviation Administration) and/or other criteria, such as stricter avoidance rules for overflight of densely populated areas, regardless of altitude in OEI operations. The OEI data can include ODP data. The OEI data includes a regulatory OEI flying distance for the aircraft.

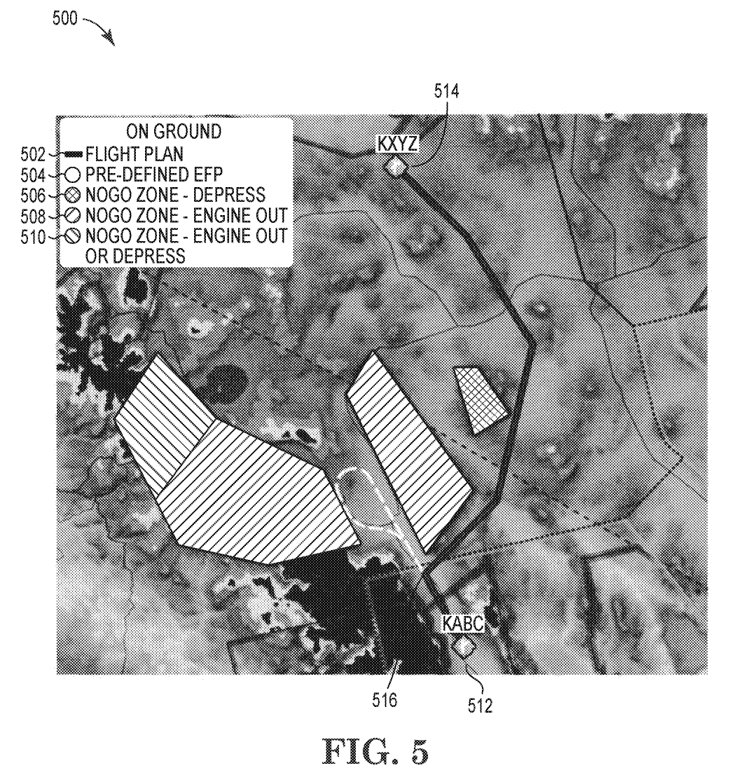

FIG. 5 illustrates an example of a user interface displaying an OEI path 504 in a preflight environment 500. In some embodiments, the OEI path 504 is displayed via the computer 302 or the integrated avionics system 100 described above. The user interface may be interactive such that the user may zoom, pan, click, and manipulate images on the display. In some embodiments, the OEI path 504 is displayed on a touchscreen device and the interaction is performed via the touchscreen. By way of example, the user interface can be a PFD, MFD, or a mobile device display.

The user interface displays a multi-layered risk awareness tool designed to support flight crews in evaluating both the planned AEO path 502 and an OEI path 504 (e.g., contingency routing in the event of an engine failure or other performance degradation). In some embodiments, the user interface can be configured to display the OEI path 504 without displaying the AEO path 502, which may be useful to the crew for a focused briefing on the OEI path 504. In some embodiments, the user interface can display a visual overlay of the AEO path 502 and an OEI path 504 simultaneously. For embodiments in which both paths are displayed simultaneously, the crew can identify where and how the OEI path 504 deviates from the AEO path 502, reinforcing awareness of limitations under degraded power conditions. The user interface can be configured to allow a user to select between simultaneously displaying both the AEO path 502 and the OEI path 504 or individually displaying either path.

The AEO path 502 can be displayed as a relatively dark (e.g., magenta on a color display) solid line, extending from a departure airport 512 (KABC) to a destination airport 514 (KXYZ). The OEI path 504 can be displayed with a unique line style (e.g., a line style different than other line styles displayed on the user interface). For example, the OEI path 504 can be displayed as a relatively light (e.g., white on a color display) dashed line. The OEI path 504 displayed in the preflight environment can be pre-defined based on aircraft-specific performance data and regulatory requirements for obstacle clearance. More specifically, the OEI path 504 can be based on OEI data including the projected OEI climb performance of the aircraft, locations of ground-based obstacles in proximity to the aircraft, obstacle clearance requirements, and a current location and altitude of the aircraft. In some embodiments, the OEI data can include the pre-defined OEI path 504 itself, which may be stored in association with airport-specific data, for example. The system can generate the OEI path 504 based on the pre-defined OEI path 504 prior to departure of the aircraft. In some embodiments, the OEI path 504 can be based on ODP data and/or other departure data, such as a SID. The OEI path 504 visually represents a flight path that meets the obstacle clearance requirements given the projected OEI climb performance, the locations of the ground-based obstacles, and the location and altitude of the aircraft.

Prominently displayed are several “No-Go Zones,” graphically overlaid using differing patterns that correspond to different hazard scenarios. The No-Go Zones can be calculated based on the predicted aircraft altitude at the AEO-to-OEI diversion point 516 and can be presented in a static format during preflight. However, the system is designed to recalculate these zones dynamically once the aircraft reaches a minimum trigger altitude (e.g., 400 feet AGL) so that the displayed data remains accurate and responsive to real-time performance. The user interface can be configured to display the OEI path 504 and the various No-Go Zones as color coded obstacle regions based on the location and altitude of the aircraft relative to the locations of the ground-based obstacles and the projected OEI climb performance of the aircraft.

Examples of such obstacles include man-made objects, such as radio towers, buildings, and weather balloons, or natural objects, such as terrain including mountains. Information about the environment around the departure airport 512, including such obstacles, can be accessible from an application such as Digital Airport Terminal Information Service (D-ATIS), from publicly available information (e.g., instrument departure procedures, obstacle departure procedures, airport diagrams, charted visual flight procedures, sectional area charts, terminal area charts, terminal procedures publication, topographical maps, etc.), and/or from private sources (e.g., Garmin Pilot^{TM}).

Areas marked with right-to-left hashing indicate OEI No-Go Zones 508, which are of elevated risk during engine-out operations. Examples of such areas include areas of high terrain relative to a current altitude of the aircraft given its climb performance, areas of bad weather (e.g., wind shear, winds that adversely affect climb performance, heavy precipitation, icing conditions, and the like), densely populated areas, etc. The engine out No-Go Zones 508 could be displayed in yellow, for example, on a color display.

Areas marked with left-to-right hashing indicate depressurization No-Go-Zones 506, which are areas of elevated risk such as during cabin depressurization operations. Examples of such areas include areas where a regulatory and/or charted minimum altitude is greater than a maximum desirable altitude for flying with a depressurized cabin (e.g., 10,000 feet above mean sea level (MSL), 14,000 feet MSL, etc.). Examples of such regulatory and/or charted minimum altitudes include minimum enroute altitudes (MEA), minimum reception altitude (MRA), minimum obstruction clearance altitude (MOCA), off-route obstruction clearance altitude (OROCA), minimum vectoring altitude, and the like. It may be dangerous and/or undesirable to fly into such areas with a depressurized cabin because the flight would be faced with either having to fly too high to breathe in a depressurized cabin or having to fly below safe minimums. The depressurization No-Go-Zones 506 could be displayed in orange, for example, on a color display. In some embodiments, No‑Go-Zones 506 may additionally or alternatively account for terrain features such as valleys, basins, or other terrain depressions that, under reduced climb performance or specific wind conditions, could expose the aircraft to downdrafts, adverse airflow, or insufficient climb‑out capability.

Areas marked with cross-hatching indicate compounded threat No-Go-Zones 510, which are areas where both OEI and cabin depressurization risks exist, and thus should be strictly avoided. The compounded threat No-Go-Zones 510 could be displayed in red, for example, on a color display.

This user interface displaying an OEI path 504 in a preflight environment allows flight crews to evaluate potential deviations, such as vector clearances issued at the time of departure. For instance, if ATC clears the aircraft for takeoff with an immediate heading of 350 degrees, the crew can use the chart to visually assess whether the new heading would intersect any pre-calculated No-Go Zones. The system thereby empowers informed go/no-go decisions at critical moments and provides a high-confidence reference for terrain and obstacle avoidance in scenarios where immediate lateral path changes may be required.

During the initial takeoff phase up to a pre-defined AEO-to-OEI diversion point 516 (e.g., an altitude threshold such as 400 feet AGL or another performance-driven milestone) the aircraft may follow the AEO path 502 as shown on the user interface (e.g., on the flight management system (FMS) or navigation display). The FMS can be programmed with the AEO path 502 in the same or analogous manner to programming a flight plan. In some embodiments, the AEO path 502 is the same as the flight plan. In some embodiments, the AEO path 502 can be obtained from the FMS. A portion of the AEO path 502 can overlap the OEI path 504 up to the AEO-to-OEI diversion point 516. In this phase, the system may present dynamically generated No-Go Zones overlaid on the moving map display, providing the flight crew with visual cues regarding terrain or obstacle clearance risks. These No-Go Zones are computed based on predicted aircraft altitude and trajectory under both AEO and OEI assumptions. If ATC issues a revised departure heading (e.g., “Fly heading 340”), the crew may quickly evaluate whether the proposed vector would intersect any of these No-Go Zones, enhancing situational awareness and enabling informed decisions about deviation acceptance during a critical window of flight.

In the event of an engine failure prior to or shortly after reaching the AEO-to-OEI diversion point 516, the system can automatically display the pre-defined OEI path 504 on the moving map display, shown as a secondary dashed line beneath or alongside the active AEO path 502. While the OEI path 504 can be determined in advance, it can be updated after departure of the aircraft based on the OEI data, for example, after the aircraft passes the AEO-to-OEI diversion point 516. In some embodiments, the OEI path 504 can be updated in response to the aircraft passing the AEO-to-OEI diversion point 516. The OEI path 504 may differ significantly from the AEO path 502 to accommodate the reduced climb gradient and maneuverability associated with single-engine operation. The OEI path 504 may include an immediate diversion away from terrain or population centers and may terminate in a designated holding pattern. This holding pattern provides the crew time and airspace to assess the situation before continuing on to a return-to-land (RTL) path, which may also be displayed once the aircraft reaches the holding fix. In some embodiments, the OEI path 504 itself can include a return-to-land path and/or a holding fix.

The system can detect an engine failure. For example, an engine failure notification can be received from an engine management system of the aircraft. The system can be configured to receive an engine failure notification from a user. In some embodiments, the system can be configured to cause the FMS of the aircraft to replace a current flight plan (e.g., the AEO path 502) with the OEI path 504 in response to the engine failure notification. Such automatic replacement can reduce pilot workload in a stressful situation.

In some embodiments, upon detecting an engine failure event, the system can prompt the flight crew, via the user interface, with a guidance acceptance dialogue, which can be displayed prominently on the PFD, MFD, or EFB. The prompt can be for the flight crew to accept and/or activate the OEI path 504 based on the engine failure notification. This prompt may state, for example, “Engine Failure Detected – Accept OEI Guidance?” and provide Accept/Reject options via touchscreen or physical controls. In some configurations, auditory cues may also accompany the prompt to draw immediate attention. This prompt enables pilot confirmation before the system transitions from the originally planned AEO path 502 procedure to the OEI path 504. Such manual confirmation ensures the crew maintains authority over flight plan changes while reducing cognitive workload by presenting a ready-to-follow solution in a time-sensitive scenario. If the crew elects to reject the OEI path 504, the current AEO path 502 remains active, and the system continues to update No-Go Zones accordingly.

If the crew accepts and/or activates the OEI path 504, the system can replace the active AEO path 502 with the OEI path 504 in response, updating all associated symbology, performance predictions, and waypoint sequencing in the navigation display. The system can cause the FMS of the aircraft to replace a current flight plan (e.g., the AEO path 502) with the OEI path 504 in response to the user accepting the OEI path 504. In some embodiments, the system can cause the user interface to stop displaying the AEO path 502 in response to the user accepting the OEI path 504. The lateral path, vertical profile, and associated terrain clearance symbology can be re-centered around the OEI path strategy, and the system may also highlight remaining No-Go Zones relevant to the updated trajectory. This transition ensures the aircraft remains on a safe and verified trajectory under degraded performance conditions, with a clear path to a safe holding point and ultimate return-to-land destination.

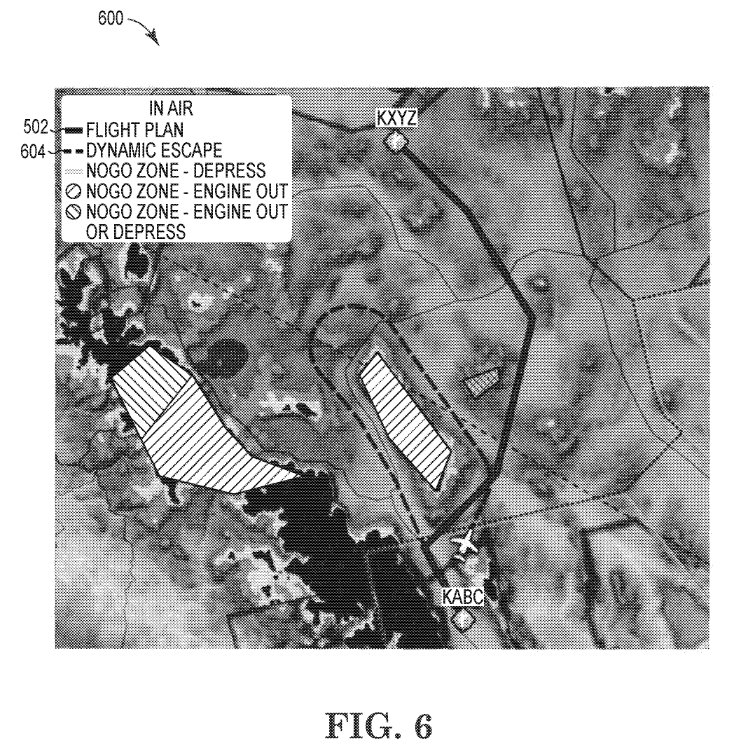

FIG. 6 illustrates an example of a user interface displaying an OEI path 604 in a flight environment 600. After the aircraft passes the pre-defined AEO-to-OEI diversion point and continues its climb toward 10,000 feet MSL, the system continues to monitor for deviations from expected performance and remains prepared to guide the crew through an engine-out scenario if necessary. While the aircraft remains on the active AEO path 502, the system dynamically displays No-Go Zones on the user interface. These zones are projected based on real-time aircraft altitude, projected climb trajectory, and terrain or obstacle databases. If ATC issues an alternate heading or vector during this intermediate climb phase, the flight crew may refer to the No-Go Zones to assess whether the revised clearance can be safely accepted. The presence of such visual indicators ensures the aircraft maintains safe separation from terrain and obstacles even when deviating from the standard instrument departure (SID) routing.

In the event an engine failure is detected during this climb segment (after the initial AEO-to-OEI diversion point but before reaching 10,000 feet MSL), the system can automatically generate and display an updated OEI path 604 based on the previously mentioned OEI data, albeit updated for the current location and altitude of the aircraft. The OEI path can be continuously updated such that the updated OEI path 604 continues to meet the obstacle clearance requirements given the projected OEI climb performance, the locations of ground-based obstacles, and the location and altitude of the aircraft. In some embodiments, the updated OEI path 604 can be determined by the FMS. The updated OEI path 604 is depicted as a dashed line on the user interface, shown alongside the AEO path 502, represented by a solid line. The updated OEI path 604 may diverge from the AEO path 502 and route the aircraft to a nearby holding fix, allowing for safe altitude stabilization and time for the flight crew to assess the situation. From the holding pattern, a return-to-land (RTL) path is depicted, routing the aircraft back to the departure airport or another designated alternate with safe terrain clearance and regulatory compliance.

If the crew accepts the updated OEI path 604, the system transitions the active route from the AEO path 502 to the updated OEI path 604. This change updates the aircraft’s lateral navigation (LNAV) and vertical navigation (VNAV) sequencing to reflect the new trajectory and modifies any active guidance cues. Terrain and obstacle alerting also reconfigures to align with the revised path, including updated No-Go Zones relative to the new route. The aircraft may then proceed to the holding pattern for stabilization, followed by the RTL path as dictated by operational procedures or ATC coordination.

As illustrated in FIG. 6, the updated OEI path 604 diverts from the AEO path 502 and leads toward a safer corridor with a holding pattern for stabilization. When the aircraft is operating above 10,000 feet MSL under nominal (AEO) conditions, the system continues to provide real-time situational awareness through the display of No-Go Zones. These zones, calculated using terrain databases and projected aircraft performance, are overlaid on the user interface to allow flight crews to assess the risk of deviating from the planned AEO route. If a proposed flight plan modification, such as a vector or reroute issued by ATC, would intersect a No-Go Zone, the system alerts the crew prior to route activation. This pre-activation warning enables the flight crew to evaluate the terrain and obstacle clearance implications of the modification before committing, supporting strategic decision-making during the enroute phase of flight.

In the event a failure is detected while above 10,000 feet MSL, such as an engine-out event or a cabin depressurization, the system can generate an on-screen prompt notifying the flight crew of the detected failure. The prompt includes an acknowledgment request, ensuring crew awareness before additional guidance is presented. Upon acknowledgment, the system evaluates whether an immediate escape maneuver is required. For scenarios such as rapid cabin depressurization or cases with only one viable airport within reach, the system automatically generates and displays a dynamic escape path. This escape path may include an emergency descent followed by a direct route to a designated suitable diversion airport, with terrain clearance and performance constraints factored into the route generation.

If immediate escape is not required, the system presents the flight crew with a curated list of diversion airports based on performance, weather, and obstacle clearance data. Each airport listing includes key decision-making parameters such as distance, estimated time enroute (ETE), predicted fuel remaining upon arrival, landing distance margin based on runway length and braking conditions, crash fire rescue (CFR) capability, highest obstruction in proximity, and the minimum safe cruise altitude. Once the flight crew selects a suitable diversion, the system generates and displays an FMS-determined updated OEI path 604 to the chosen airport. This escape path is overlaid as a secondary dashed route alongside the active AEO route, allowing the crew to visually compare and evaluate both paths.

Upon user acceptance of the updated OEI path 604, the system transitions from the AEO path 502 to the updated OEI path 604. This transition updates the aircraft’s lateral and vertical navigation cues, recalibrates terrain and obstacle alerting based on the new profile, and clears any conflicting AEO paths 502. The No-Go Zones are recalculated in accordance with the new trajectory and current aircraft performance parameters.

Additional logic may be applied to evaluate the suitability of diversion airports under both OEI and depressurization scenarios. When operating below the aircraft’s OEI service ceiling, the system determines and displays a minimum cruise altitude required to safely reach each candidate diversion airport. This minimum cruise altitude accounts for obstacle clearance along the route as well as required fuel reserves. Minimum fuel requirements may be configured by operator policy or regulatory standard and are used as gating criteria for suitability. If the aircraft is unable to climb to the required minimum cruise altitude (based on current weight, environmental conditions, and engine-out performance), the airport is deemed unsuitable and excluded from the recommended diversion list.

In scenarios where the aircraft is operating above the OEI service ceiling at the time of engine failure, the system overlays a computed driftdown profile on the user interface. This profile is evaluated against terrain and obstacle data to ensure safe clearance throughout the descent to an achievable cruise altitude. If terrain clearance is assured and sufficient fuel is available to reach a suitable airport from the driftdown level-off point the system proceeds with the same suitability checks used for lower cruise levels. In depressurization events, an emergency descent profile is similarly calculated and evaluated to determine whether the aircraft can meet obstacle clearance and fuel requirements while descending to a breathable altitude (e.g., FL100 or MEA). Only those airports reachable under these constraints are presented to the crew, ensuring all diversion guidance is both operationally feasible and terrain-compliant.

In various embodiments, the system may be configured to detect and respond to a range of dynamic aircraft failures beyond traditional OEI events. These may include, for example, environmental control system failures such as cabin depressurization, hydraulic or electrical system faults that degrade control authority, or flight control surface malfunctions that affect climb performance or maneuverability. Each failure type may trigger tailored guidance logic appropriate to the operational context, such as modified climb profiles, early return-to-land options, or emergency descent procedures. The system may dynamically assess the severity and operational impact of the detected failure, and initiate chart updates, path overlays, or decision prompts accordingly. In this way, a unified guidance framework can accommodate multiple failure modalities while preserving clear, phase-appropriate flight crew cues.

Additionally, variations in the source or timing of guidance activation may be supported. For example, some failures may prompt automatic display of a secondary escape path overlaid on the existing flight plan, while others may require pilot acknowledgment before alternate guidance is shown. Certain failures may trigger preloaded escape routes, such as for depressurization or known airport-specific OEI paths, while others invoke dynamic path generation based on real-time aircraft state and environmental inputs. Regardless of the failure type, the system ensures that the flight crew is presented with actionable, context-relevant information through graphical overlays, performance summaries, and risk indicators such as No-Go Zones.

In various embodiments, the dynamic guidance such as OEI paths, depressurization descent profiles, and associated No-Go Zones may be displayed across multiple flight deck interfaces to ensure accessibility and situational awareness in all phases of flight. This dynamic guidance may be rendered as dynamic moving maps on the MFDs, allowing for real-time updates and interactive panning, zooming, or decluttering by the flight crew. Additionally, the dynamic guidance may be accessible via electronic flight bags (EFBs) or tablet-based applications, either integrated into the aircraft’s avionics suite or operating independently with synchronized data inputs. In response to certain events, such as an engine failure or failure acknowledgment, the system may also generate pop-up overlays or dedicated insets on the primary flight displays (PFDs), ensuring that critical escape guidance and terrain awareness symbology are immediately visible without requiring pilot-initiated navigation through menus.

In some embodiments, the dynamic guidance generated in response to dynamic failures, such as OEI paths, depressurization descent routes, or diversion profiles, may be integrated with the aircraft’s autopilot and autoland systems to support automated execution of emergency procedures. For example, in aircraft equipped with Garmin Autoland or similar autonomous landing technologies, the system may use the displayed escape paths and diversion airport data to identify a suitable landing site, initiate an emergency descent if required, and navigate to the selected airport while actively avoiding No-Go Zones and terrain threats. Once the route is established, the autopilot may engage to follow the lateral and vertical guidance automatically, managing speed, altitude, and aircraft configuration. In scenarios where Autoland is activated, the system can seamlessly transition from the escape or diversion phase to a stabilized approach and automated landing at the selected airport.

The term “computer-readable storage medium” should be taken to include a single medium or multiple media that store the one or more sets of instructions. The term “computer-readable storage medium” shall also be taken to include any medium that is capable of storing or encoding a set of instructions for execution by a processor and that cause a device to perform any one or more of the methodologies of the present disclosure. The term “computer-readable storage medium” shall accordingly be taken to include, but not be limited to, solid-state memories, optical media, and magnetic media, whether provided in a local or distributed manner (e.g., cloud storage).

At least one embodiment can include a processor configured to obtain OEI data to generate an OEI path based on the OEI data and a user interface configured to display the OEI path with a unique line style. The OEI data can include projected OEI climb performance of the aircraft, locations of ground-based obstacles in proximity to the aircraft, obstacle clearance requirements, and a location and altitude of the aircraft. The OEI path visually represents a flight path that meets the obstacle clearance requirements given the projected OEI climb performance, the locations of ground-based obstacles, and the location and altitude of the aircraft.

At least one embodiment can include a processor configured to obtain AEO data to generate an AEO path based on the AEO data and to obtain OEI data to generate an OEI path based on the OEI data and a user interface configured to display the AEO path and the OEI path simultaneously with different line styles. The OEI data can include projected OEI climb performance of the aircraft, locations of ground-based obstacles in proximity to the aircraft, obstacle clearance requirements, and a location and altitude of the aircraft. The OEI path visually represents a flight path that meets the obstacle clearance requirements given the projected OEI climb performance, the locations of ground-based obstacles, and the location and altitude of the aircraft.

At least one embodiment can include a processor configured to obtain OEI data to generate an OEI path based on the OEI data and a user interface. An FMS of the aircraft can be programmed with an AEO path. The user interface can be configured to display the AEO path and the OEI path simultaneously with different line styles. The OEI data can include projected OEI climb performance of the aircraft, locations of ground-based obstacles in proximity to the aircraft, obstacle clearance requirements, a location of the aircraft based on input from a GNSS receiver, and an altitude of the aircraft based on input from an altimeter. The OEI path visually represents a flight path that meets the obstacle clearance requirements given the projected OEI climb performance, the locations of ground-based obstacles, and the location and altitude of the aircraft.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

The terms “user” and “pilot” are used interchangeably herein to describe any pilot, co-pilot, crew member, or other person who operates or controls the aircraft and/or user interface.

As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected and, unless stated otherwise, can include a wireless connection. As will be appreciated, elements shown in the various embodiments herein can be added, exchanged, and/or eliminated so as to provide a number of additional embodiments of the present disclosure.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system for dynamic guidance for aircraft, comprising:
a processor configured to obtain one-engine-inoperative (OEI) data to generate an OEI path based on the OEI data, the OEI data comprising:
projected OEI climb performance of the aircraft;
locations of ground-based obstacles in proximity to the aircraft;
obstacle clearance requirements; and
a location and altitude of the aircraft; and
a user interface configured to display the OEI path with a unique line style;
wherein the OEI path visually represents a flight path that meets the obstacle clearance requirements given the projected OEI climb performance, the locations of ground-based obstacles, and the location and altitude of the aircraft.

2. The system of claim 1, wherein the OEI data includes a pre-defined OEI path; and
wherein the processor is configured to:
generate the OEI path based on the pre-defined OEI path prior to departure of the aircraft; and
update the OEI path after departure of the aircraft based on the OEI data.

3. The system of claim 2, wherein the system is coupled to a flight management system (FMS) of the aircraft programmed with an all-engines-operative (AEO) path;
wherein a portion of the AEO path overlaps the OEI path up to a diversion point; and
wherein the processor is configured to update the OEI path in response to the aircraft passing the diversion point.

4. The system of claim 3, wherein the user interface is configured to display the AEO path and the OEI path simultaneously.

5. The system of claim 1, wherein the OEI data includes an engine failure notification from an engine management system of the aircraft, and wherein the processor is configured to:
prompt a user, via the user interface, to accept the OEI path based on the engine failure notification;
cause a flight management system (FMS) of the aircraft to replace a current flight plan with the OEI path in response to the user accepting the OEI path; and
cause the user interface to stop displaying the current flight plan in response to the user accepting the OEI path.

6. The system of claim 1, wherein the OEI data includes an engine failure notification from an engine management system of the aircraft, and wherein the processor is configured to cause a flight management system (FMS) of the aircraft to replace a current flight plan with the OEI path in response to the engine failure notification.

7. The system of claim 1, wherein the OEI path is updated continuously such that the OEI path continues to meet the obstacle clearance requirements given the projected OEI climb performance, the locations of ground-based obstacles, and the location and altitude of the aircraft.

8. The system of claim 1, wherein the OEI data includes location-referenced population data and avoidance criteria for locations based on population density.

9. The system of claim 1, wherein the OEI path includes a return-to-land path and/or a holding fix.

10. The system of claim 1, wherein the OEI data includes obstacle departure procedure (ODP) data; and
wherein the processor is configured to generate the OEI path based on the ODP data.

11. The system of claim 1, wherein the user interface is one of a primary flight display, a multifunction display, and a mobile device display.

12. The system of claim 1, wherein user interface configured to display the OEI path and a plurality of obstacle regions color coded based on:
the location and altitude of the aircraft relative to the locations of the ground-based obstacles; and
the projected OEI climb performance.

13. A system for dynamic guidance for aircraft, comprising:
a processor configured to obtain all-engines-operative (AEO) data to generate an AEO path based on the AEO data and to obtain one-engine-inoperative (OEI) data to generate an OEI path based on the OEI data, the OEI data comprising:
projected OEI climb performance of the aircraft;
locations of ground-based obstacles in proximity to the aircraft;
obstacle clearance requirements; and
a location and altitude of the aircraft; and
a user interface configured to display the AEO path and the OEI path simultaneously with different line styles;
wherein the OEI path visually represents a flight path that meets the obstacle clearance requirements given the projected OEI climb performance, the locations of ground-based obstacles, and the location and altitude of the aircraft.

14. The system of claim 13, wherein the AEO data includes a standard instrument departure (SID); and
wherein the processor is configured to generate the AEO path based on the SID.

15. The system of claim 13, wherein the system is coupled to a flight management system (FMS) of the aircraft programmed with the AEO path;
wherein the AEO data includes the AEO path and the processor is configured to obtain the AEO path from the FMS;
wherein a portion of the AEO path overlaps the OEI path up to a diversion point; and
wherein the processor is configured to update the OEI path in response to the aircraft passing the diversion point.

16. The system of claim 15, wherein the processor is configured to:
display a prompt to a user, via the user interface, to activate the OEI path; and
cause the FMS to replace the AEO path with the OEI path in response to the user activating the OEI path.

17. A system for dynamic guidance for aircraft, comprising:
a processor configured to obtain one-engine-inoperative (OEI) data to generate an OEI path based on the OEI data, the OEI data comprising:
projected OEI climb performance of the aircraft;
locations of ground-based obstacles in proximity to the aircraft;
obstacle clearance requirements;
a location of the aircraft based on input from a global navigation satellite system (GNSS) receiver; and
an altitude of the aircraft based on input from an altimeter;
wherein the system is coupled to a flight management system (FMS) of the aircraft programmed with an all-engines-operative (AEO) path; and
a user interface configured to display the AEO path and the OEI path simultaneously with different line styles;
wherein the OEI path visually represents a flight path that meets the obstacle clearance requirements given the projected OEI climb performance, the locations of ground-based obstacles, and the location and altitude of the aircraft.

18. The system of claim 17, wherein the OEI data includes an engine failure notification from an engine management system of the aircraft, and wherein the processor is configured to:
prompt a user, via the user interface, to accept the OEI path based on the engine failure notification; and
cause the FMS to replace a current flight plan with the OEI path in response to the user accepting the OEI path.

19. The system of claim 18, wherein the user interface is configured to stop displaying the AEO path in response to the user accepting the OEI path.

20. The system of claim 17, wherein the OEI data includes a regulatory OEI flying distance for the aircraft.
